(19) United States
(12) Patent Application Publication
(10) Pub. No.: US 2010/0282417 A1
(43) Pub. Date: Nov. 11, 2010

(54) PRESS FOR LAMINATING ESSENTIALLY PLATE-SHAPED WORK PIECES

(75) Inventors: Norbert Damm, Karlsdorf-Neuthard (DE); Wolfgang Renz, Freudenstadt (DE)

Correspondence Address: VOLPE AND KOENIG, P.C., UNITED PLAZA, 30 SOUTH 17TH STREET, PHILADELPHIA, PA, 19103, US

(73) Assignee: ROBERT BURKLE GMBH, Freudenstadt (DE)

(21) Appl. No.: 12/775,581

(22) Filed: May 7, 2010

(30) Foreign Application Priority Data
May 7, 2009 (DE) 102009020172.6

(51) Int. Cl. B30B 5/02

(52) U.S. Cl. 156/583.3

(57) ABSTRACT

A press for laminating essentially plate-shaped work pieces under the effect of pressure and heat is provided, with a lower press half (2) and an upper press half (3) that can move relative to each other in order to open and to close the press. The lower press half (2) and the upper press half (3) form, through the use of peripheral, one-part or multi-part seals (12, 13), in the closed state, a vacuum chamber (14). A flexible membrane (11) divides the vacuum chamber (14) into a product space (16) that can be evacuated and that is provided for holding at least one work piece (1) and into a pressure space (17) that can be evacuated and/or pressurized. The membrane (11) is constructed and arranged so that it presses the work piece (1) directly or indirectly against a bottom side (2) of the vacuum chamber (14) due to a pressure difference generated through evacuation of the product space (16) and/or through pressurization of the pressure space (17) in the vacuum chamber (14). A transport band (4) runs through the vacuum chamber (14) and the work piece (1) is arranged thereon. The transport band (4) is structured at least on its surface facing the work piece (1) such that gas transport is possible within the transport band volume and at least partially along its surface.

### CROSS-REFERENCE TO RELATED APPLICATIONS

This application claims the benefit of German Patent Application No. 10 2009 020 172.6, filed May 7, 2009, which is incorporated herein by reference as if fully set forth.

### BACKGROUND

The invention relates to a press for laminating essentially plate-shaped work pieces under the effect of pressure and heat.

A press of the present type consequently comprises a lower press half and an upper press half that can be moved relative to each other, in order to open and to close the press. In the closed state, the lower press half and the upper press half form a vacuum chamber using peripheral, one-part or multiple-part seals, wherein one or more work pieces are laminated within this vacuum chamber. A flexible membrane divides the vacuum chamber into a product space that can be evacuated and that is provided for holding at least one work piece and into a pressure space that can be evacuated and/or pressurized. Due to a pressure difference in the vacuum chamber generated by the evacuation of the product space and/or by the pressurization of the pressure space, the membrane is pressed against the work piece, wherein it presses the work piece directly or indirectly against a bottom side of the vacuum chamber and in this way applies the load necessary for lamination onto the work piece. As a rule, the bottom side of the vacuum chamber is formed by a heating plate, so that the process heat required for lamination is introduced into the work piece directly during the pressing process. However, other methods of introducing the process heat are also possible.

Here the work piece does not lie directly on the bottom side of the vacuum chamber, but instead on a transport band that lies, on its side, on the bottom side of the vacuum chamber during the lamination process.

A press of the present type is preferably used for the lamination of photovoltaic modules. These typically consist of a solar cell layer that is arranged together with its electrical contact elements between a glass plate and a weather-resistant film or between two glass plates and laminated by one or more adhesive layers with the glass plates or films and is thus encapsulated in a moisture-tight and also weather-resistant way in an optically transparent layer composite.

Now in order to laminate one work piece or multiple work pieces at the same time—for the sake of simplicity, only one work piece is discussed below—the work piece is moved into the product space of the vacuum chamber and the vacuum chamber is closed. The pressure space of the vacuum chamber is then normally evacuated first, in order to draw the membrane upward to the upper chamber half. Then, typically with a certain time offset, the product space is also evacuated, wherein the evacuation of both spaces of the vacuum chamber is regulated so that a differential pressure between the pressure space and the product space always remains, wherein this differential pressure holds the membrane in the upper chamber half and prevents the membrane from coming into premature contact with the work piece.

When the product space of the press chamber has been evacuated up to a desired pressure that usually lies below 1 mbar, air is fed to the pressure space, so that the pressure difference between the pressure space and the product space reverses and the membrane contacts the work piece. By regulating the pressure in the pressure space, a desired contact pressure of the membrane is set, in order to generate the load required for the lamination on the work piece.

The process heat required for the lamination process is typically introduced into the work piece, such that the bottom side of the vacuum chamber is constructed as a heating plate against which the work piece is pressed by the membrane. The pressure and the process heat together then provide for the softening or activation of the adhesive layer and optionally for their hardening or cross-linking.

The rapid evacuation, especially of the product space of the vacuum chamber—as much as possible before a significant heating of the work piece—makes it possible for any air inclusions (entrapped air between the work piece layers) or gases possibly formed during the heating to be drawn out from the work piece before the adhesive in the adhesive layer begins to harden or to become cross-linked. This is because gas bubbles in the finished, laminated work piece negatively affect its service life to a very significant degree or lead, in the most unfavorable case, to the immediate uselessness of the work piece, that is, to the production of defective goods.

After the heating of the work piece under a vacuum, the actual lamination process begins through the contact of the membrane, while the membrane applies the load necessary for this process onto the work piece. Due to the pressure difference between the product space and the pressure space, the usually highly elastic membrane forms an intimate contact both on the upper side and also on all side surfaces of the work piece, wherein, next to the work piece, it presses against the bottom side of the vacuum chamber until coming up directly against the work piece. Because a transport band is provided on which the work piece is transported into and out from the vacuum chamber and that therefore contacts, passing through the vacuum chamber, the bottom side of the vacuum chamber, first, the work piece is pressed against the transport band and thus indirectly against the bottom side of the vacuum chamber and, second, the membrane also contacts directly on the top side of the transport band, in addition to the work piece.

Therefore, because the membrane forms an intimate contact on the work piece on all sides, it closes the work piece in a gas-tight way and prevents, in particular, that gases generated, for example, in the work piece during the actual lamination phase can be drawn out and suctioned. This increases the risk of bubble formation in the work piece to a very significant degree.

This effect occurs primarily when the product space is no longer further suctioned during the lamination phase. However, even when suction openings are provided in the bottom side of the vacuum chamber, that is, the product space is evacuated not to the side, but instead downward, and is also further suctioned during the lamination process, through its elastic contact on the outer contours of the work piece, the membrane prevents gases generated in the work piece from being able to reach the suction openings, because these are covered by the membrane.

Previous approaches attempted to solve these problems by fixing the membrane in a double frame on the top chamber half. In the highly suctioned state of the membrane during the evacuation phase and in the closed state of the vacuum chamber, without differential pressure, the membrane is here set apart from the plane on which the work piece lies typically by a height of 15 to 50 mm. Because it is regularly necessary to change the membrane, however, such a double frame is not optimal, because it complicates changing the membrane and thus prolongs the downtime of the press for a required membrane change.

In addition to the disadvantageous properties just mentioned for a double frame, the problem is also solved only inadequately. This depends very likely on that, during the load change from the evacuation state in the pressure space to the pressurized state in the clamped regions on the double frame, the membrane is first relaxed and then, due to the suction effect of the suctioning cross sections in the product space, it first contacts the edge regions of the bottom side of the vacuum chamber and in this way seals the suction openings. The gases remaining in the product space even at a residual pressure of only 1 mbar are then compressed again at a higher pressure due to the decreasing residual volume. In addition, process gases generated during the process, such as, residual moisture, catalyst gases, vapor softeners, etc., can no longer be discharged. This leads finally to a bubble formation in the work piece, which negatively affects its quality significantly.

### SUMMARY

The present invention is therefore based on the objective of providing a press of the type noted above in which the formation of bubbles in the work piece is prevented or at least significantly reduced.

This objective is met by a press according to the invention. Preferred constructions and refinements of the press according to the invention are described below.

According to the invention, the objective is met essentially in that the elements of the press directly contacting the work piece during the pressing process have a surface structured relative to the work piece such that gas-conducting channels running at least partially along the surface are formed therein. These channels running along the surface can extend across the entire length or width of the work piece, but they could also have a very short construction, if they open into vertical openings or channels or the like running within the work piece.

In the scope of the present invention, it is proposed to modify at least the transport band. According to the invention it should be structured at least on its surface facing the work piece such that gas transport is possible within the transport band volume and, indeed, at least partially along its surface.

Additional elements of the press directly contacting the work piece during the pressing process can be the surface of the bottom side of the vacuum chamber, that is, in particular, the surface of a heating plate, as well as additionally or alternatively the surface of the membrane facing the work piece.

Thus, due to the measures according to the invention, gases generated, for example, during the lamination process or still remaining in the product space can essentially reach along the surface of the vacuum chamber bottom side and optionally also the membrane bottom side up to suction openings of the product space despite a tight membrane and can also be suctioned there during the actual lamination process.

Transport bands that are used during the lamination, in particular, of photovoltaic modules, are typically relatively thin, i.e., their thickness lies under a millimeter, in order to obstruct the seal of the peripheral seals between the lower press half and the upper press half as little as possible; this is because the nature of a transport band is to pass through the vacuum chamber even for a closed press and it is thus clamped on two sides of the vacuum chamber in the peripheral seals.

Typical transport bands are PTFE-coated fabric bands, advantageously, tightly woven glass-fiber fabric with PTFE-sheathed fibers that are also coated on both sides with PTFE. PTFE coating has proven very effective against adhesive residue unintentionally coming from work pieces. The thin construction of the transport bands that are as much as possible only between 0.2 and 0.5 mm thick in the region of the work pieces, in order to guarantee heat transfer that is as good as possible between the heating plate and the work piece, consist of very thin fibers and must consequently have a corresponding tight-weave mesh. In this way and through the additional coating with PTFE, these typical transport bands are provided with an approximately flat, smooth surface and a closed-pore fabric structure. This has even been explicitly desired due to the necessary sealing of the vacuum chamber to the outside, as mentioned above.

The modification according to the invention of the transport band is advantageously realized such that the transport band is constructed as a mesh fabric. A mesh fabric structure forms three-dimensionally active channels that have, in addition to vertical cross sections, also horizontal cross sections. The gas-conducting cross sections acting both in the vertical and also in the horizontal direction of a mesh fabric structure connect such that, in each mesh of the mesh fabric, there are four crossings of the fabric threads and these many crossing points at the neighboring surfaces lying above and below the mesh fabric function as tiny local spacers. The sum of all of the node cross sections formed in this way is also sufficient in the pressed state of these neighbor surfaces to discharge residual air and generated process gases through gas-conducting channels along the transport band surface to the suction openings of the product space.

The mesh fabric structure of the transport band is advantageously constructed so that the mesh width of the fabric structure as a ratio to the fabric thread thickness equals approximately 1:1 to 5:1, advantageously approximately 3:1. The fabric threads can be, as before, PTFE-saturated and encased with PTFE, and can nevertheless maintain the gas-discharging effect according to the invention.

Because such a structure of the transport band increases the leakage rate at the point at which the transport band passes through the seals between the upper press half and the lower press half, there are advantages when the transport band is constructed as a mesh fabric or provided with other surface channels essentially only in the region contacting the work piece. In those areas of the transport band on which the seals of the upper and/or lower press half contact, the transport band can be provided accordingly with an essentially closed, flat surface. As an additional advantageous construction of the transport band, it is proposed to form this as a mesh fabric made from plastic threads that resistant to temperatures of up to ca. 200° C., wherein additional metal threads are worked in, in order to increase the heat conductivity of the transport band and thus to guarantee an optimal heat transfer between the bottom side of the vacuum chamber that is typically constructed as a heating plate and the work piece.

The transport band can have a gas-permeable construction both horizontally and also vertically, especially when it is constructed as a mesh fabric, at least in the area contacting the work piece, in order to guarantee optimum discharge of any generated gases or residual gases during the actual lamination process. In this case, in order to protect the bottom side of the vacuum chamber from any adhesive residues passing through the transport band, it can be provided to introduce a thin protective film between the transport band and the bottom side of the vacuum chamber.

Finally, the transport band can also be constructed from a multi-layer composite at least in the region contacting the work piece, wherein this composite is made from an open-pore mesh fabric and one or more gas-tight films.

For protecting the membrane from adhesive residue, it is typical, especially for photovoltaic laminators, to introduce a separation film between the membrane and the work piece. In the scope of the present invention, such a separation film could likewise be provided with a surface structured such that gas transport is possible along this surface.

In the scope of the present invention, however, it is especially advantageous when the separation film has a gas-tight construction and is dimensioned so that it prevents contact of the membrane with gases that are discharged from the work piece during the lamination process. This is because, according to experience, conventional silicon membranes or membranes made from natural rubber are attacked by the gases that are discharged from the EVA adhesive films (ethylene vinyl acetate) typically used for the production of photovoltaic modules during the lamination process. This leads to greatly shortened service lives of the membranes.

In particular, through a combination of a three-dimensionally structured transport band with a gas-tight, smooth separation film, in the pressing phase with applied membrane, an inner processing space in the product space can be formed that allows no direct gas inlet to the membrane bottom side.

The separation film is incidentally advantageously dimensioned so that it covers the membrane within the vacuum chamber and in this way completely covers the press relative to the product space. In particular, the separation film then reaches, viewed in the transport direction of the work pieces, to the left and right past optional suction openings up to below the frame construction of the membrane.

### BRIEF DESCRIPTION OF THE DRAWINGS

Two embodiments of a press constructed according to the invention are described and explained in detail below with reference to the enclosed drawings. Shown are:

FIG. 1 is a schematic section diagram of a press constructed according to the invention, perpendicular to the direction of passage;

FIG. 2 is a schematic section diagram of the press from FIG. 1, parallel to the direction of passage,

FIG. 3 is a diagram like FIG. 1, but of a modified embodiment, and

FIGS. 4, 5, and 6 are schematic section diagrams like FIG. 1, but of a press according to the state of the art, in the opened and closed state, as well as during the lamination phase.

### DETAILED DESCRIPTION OF THE PREFERRED EMBODIMENTS

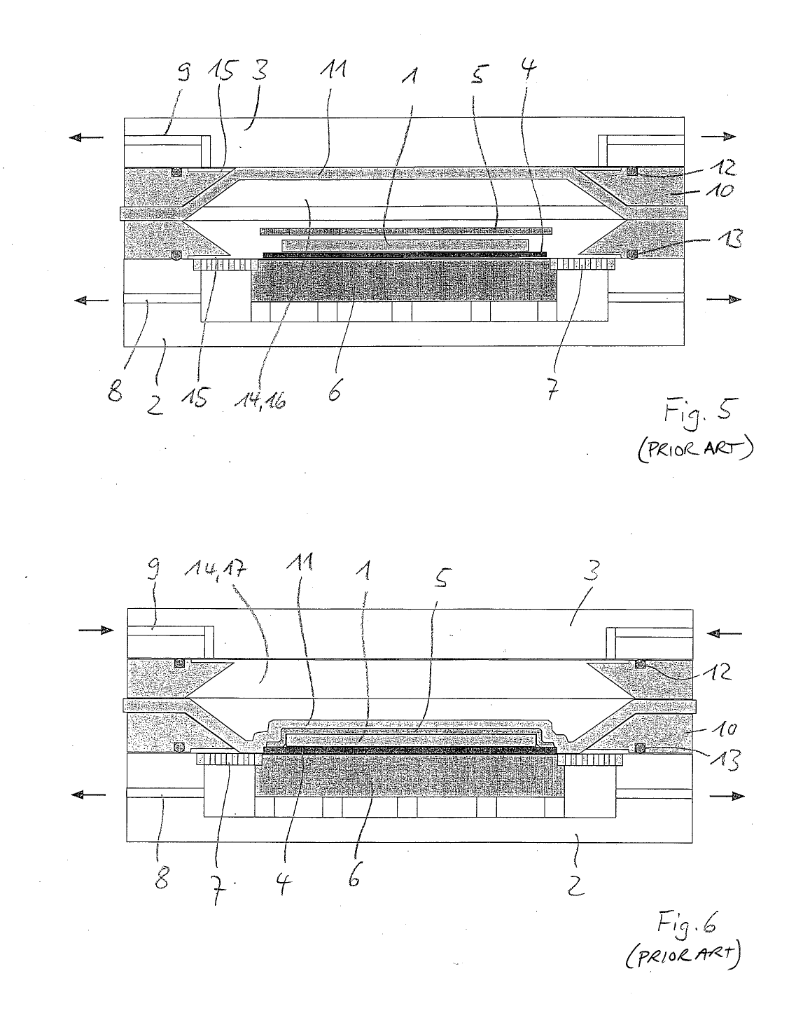

Initially, with reference to FIGS. 4 to 6, the prior art will be described. In these figures, a press for laminating photovoltaic modules according to the prior art is shown schematically, and, indeed, in a sectional representation perpendicular to the passage direction of a photovoltaic module 1, wherein FIG. 4 shows an opened press, FIG. 5 shows a closed press during evacuation, and FIG. 6 shows a closed press during the actual lamination process.

In the press that is formed from a lower press half 2 and an upper press half 3, a photovoltaic module 1 is arranged between a conveyor belt 4 and a separation film 5. The conveyor belt 4 contacts the lower press half 2 that has, in this region, a heating plate 6, in order to introduce the necessary processing heat into the photovoltaic module 1. Viewed in the passage direction laterally next to the heating plate 6, in the lower press half 2 there are several suction openings 7 that open into lower channels 8. The lower channels 8 are connected to evacuation and ventilation means (not shown here). The transport band 4 is used to introduce the photovoltaic module 1 into the press and to transport it back out again, so that it passes through the press perpendicular to the plane of the drawing.

The upper press half 3 is provided with upper channels 9 for evacuation, ventilation, or pressurization, and it carries a double frame 10 in which a membrane 11 is held in tension. With the upper 12 and lower peripheral seals 13 that seal the upper press half 3 and the lower press half 2, respectively, the double frame 10 forms a multiple-part seal for the gas-tight sealing of the press, wherein it circumscribes a vacuum chamber 14 in its interior, together with the bordering press halves 2, 3. By means of recesses 15, the vacuum chamber 14 is connected to the lower and upper channels 8, 9. The membrane 11 divides the vacuum chamber 14 into a product space 16 that lies underneath the membrane and that is connected to the lower channels 8 and into a pressure space 17 that lies above the membrane 11 and that is connected to the upper channels 9.

FIG. 4 now shows the phase in which the photovoltaic module 1 has been moved on the transport band 4 with contacting separation film 5 into the region of the vacuum chamber 14 in the press; here the press is still open. In order to protect the membrane 11 from mechanical damage, it is drawn onto the upper press half 3 by the upper channels 9.

By lowering the upper press half 3, the press is then closed, as FIG. 5 shows. Through the use of the upper channels 9 and the lower channels 8, the vacuum chamber 14 is evacuated, wherein care is taken that the pressure above the membrane 11 is less than that under the membrane 11, so that the membrane 11 remains drawn upward to the upper press half 3. Here, only the product space 16 is visible in FIG. 5, but not the pressure space 17.

After the product space 16 has been evacuated up to an end pressure of approximately one mbar, the pressure space 17 is supplied with air via the upper channels 9, so that the situation shown in FIG. 6 is produced. Due to the prevailing pressure difference, the membrane 11 is set on the photovoltaic module 1 and presses this against the heating plate 6. The separation film 5 here prevents direct contact of the membrane 11 with the photovoltaic module 1, so that any discharged adhesive cannot reach the membrane 11. The phase shown in FIG. 6 is the actual lamination phase in which the photovoltaic module 1 is pressed together by the membrane 11, while it is charged with heat from the heating plate 6 via the transport band 4.

As can be seen easily with reference to FIG. 6, the membrane 11 closely contacts the layer body formed from the photovoltaic module 1, transport band 4, and separation film 5, in particular, also at the edges, so that a kind of inner process space is formed that is separated from the suction openings 7. Residual gases and gases generated in the work piece during the lamination consequently can no longer be suctioned and lead to the formation of bubbles in the photovoltaic module 1. This effect is reinforced to a considerable extent in that the membrane 11, as FIG. 6 shows, covers the suction openings 7 in the regions bordering the transport band 4. A certain delay in this effect occurs at least in that the membrane 11 is arranged at a significant height spacing to the photovoltaic module 1 due to the double frame 10 being used and consequently first pressed against this part before the suction openings 7 are covered. According to the invention, however, it has been shown that this is a rather theoretical consideration that could not be verified in practice.

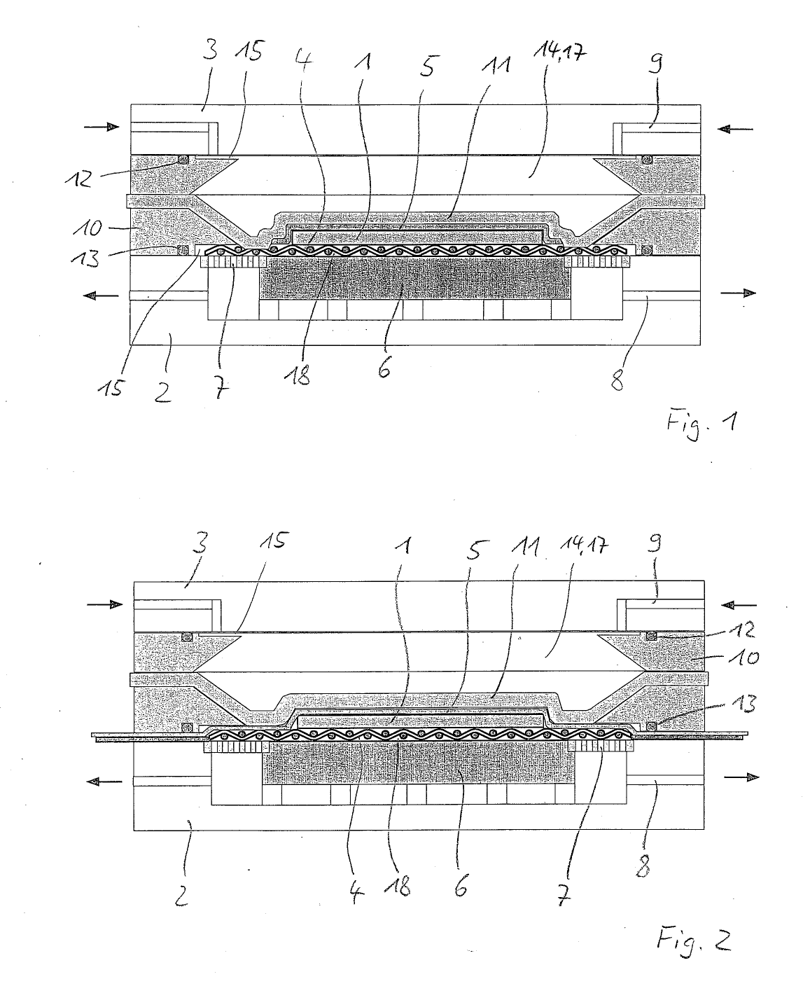

FIGS. 1 and 2 now show, as an example, a press in which the solution according to the invention is provided, wherein FIG. 1 is a representation similar to that of FIGS. 4 to 6, that is, a schematic section through the press perpendicular to the passage direction of the work pieces, while FIG. 2 is a section along the passage direction.

The decisive difference of the press shown in FIGS. 1 and 2 relative to the prior art shown in FIGS. 4 to 6 is provided in that the transport band 4 is provided with an open-pore mesh fabric structure and thus has gas-discharging cross sections active three-dimensionally, that is, in the vertical and horizontal directions, within its cross-sectional surface or within its volume. FIGS. 1 and 2 show the actual lamination phase and illustrate how the mesh fabric of the transport band 4 prevents the formation of a hermetically closed inner process space. This is because gases generated during the lamination in the photovoltaic module 1 can be discharged along the gas-conducting channels 18 running on the surface of the transport band 4 or at least as far along the surface of the transport band 4 until these pass through the transport band 4 or can be transported further within this band and, indeed, up to the suction openings 7 over which the transport band 4 extends due to an intentional excess width. As a result, gases generated during the actual lamination process in the photovoltaic module 1 or that are trapped during the lowering of the membrane 11 can be removed from the product space 16 via the suction openings 7 and the lower channels 8; a formation of bubbles in the work piece is prevented in this respect.

As FIG. 2 shows, the transport band 4 of the present embodiment is constructed as a mesh fabric only in that region in which the photovoltaic module 1 comes to lie and in which the suction openings 7 are located. Upstream and downstream in the passage direction, the transport band 4, as is typical in the prior art, is constructed as a band with the thinnest and smoothest possible construction, in order to not endanger the sealing effect of the lower seal 13 of the double frame 10 against the lower press half 2.

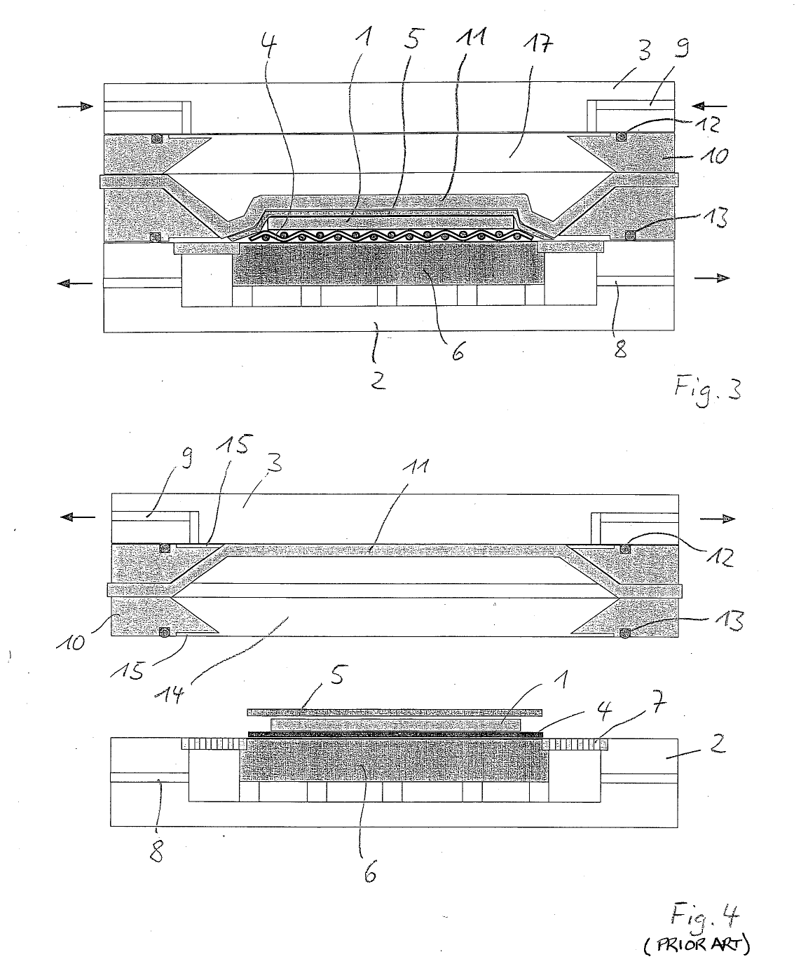

Finally, FIG. 3 shows, in a representation corresponding to FIG. 1, a modification of the embodiment described here for a press constructed according to the invention. A change is provided in that, viewed in the passage direction, no suction openings are provided laterally next to the heating plate 6; instead these are located merely upstream and downstream of the heating plate 6. Furthermore, here the transport band 4 does not have an excess width, so that it covers only the heating plate 6, as in the prior art. For this reason, the separation film 5 has an excess width construction, so that this covers laterally both the photovoltaic module 1 and also the transport band 4 and thus prevents that the membrane 11 contacts gases that originate from the photovoltaic module 1 and there, in particular, from the adhesives used therein. Because the separation film 5 passes through the press just like the transport band 4 (cf. FIG. 2), there is also no risk in the region of the suction openings 7 that the membrane 11 comes in contact with dangerous gases from the photovoltaic module 1.

Because the transport bands 4 selected here are provided with three-dimensional, open-pore structures, finally it can be advantageous (not shown here) to arrange a very thin, closed-pore, PTFE-coated film between the transport band 4 and the heating plate 6 for protecting the heating plate 6 from adhesive residue.

1. A press for laminating essentially plate-shaped work pieces under the effect of pressure and heat, comprising a lower press half (2) and an upper press half (3) that can move relative to each other, in order to open and close the press, the lower press half (2) and the upper press half (3) form, in connection with peripheral, one-part or multi-part seals (12, 13), in a closed state, a vacuum chamber (14) with a flexible membrane (11) that divides the vacuum chamber (14) into a product space (16) that can be evacuated and that is provided for holding at least one work piece (1) and into a pressure space (17) that can be evacuated and/or pressurized, the membrane (11) is constructed and arranged such that it presses the work piece (1) directly or indirectly against a bottom side (2) of the vacuum chamber (14) due to a pressure difference in the vacuum chamber (14) generated through at least one of evacuation of the product space (16) or through pressurization of the pressure space (17), and a transport band (4) that runs through the vacuum chamber (14) and on which the work piece (1) is arranged, the transport band (4) is structured at least on a surface facing the work piece (1) to allow gas transport within a volume of the transport band and at least partially along the surface.

2. The press according to claim 1, wherein the transport band (4) is constructed as a mesh fabric at least in a region contacting the work piece (1).

3. The press according to claim 2, wherein the transport band (4) is provided in regions in which the seals (13) of the upper and/or lower press half (2, 3) come to lie with an essentially closed, flat surface.

4. The press according to claim 1, wherein the transport band (4) is constructed from a multi-layer composite including an open-pore mesh fabric and a gas-tight film at least in a region contacting the work piece (1).

5. The press according to claim 4, wherein the transport band (4) is provided in regions in which the seals (13) of the upper and/or lower press half (2, 3) come to lie with an essentially closed, flat surface.

6. The press according to claim 2, wherein the mesh fabric of the transport band is formed from plastic threads that are resistant to temperatures of up to about 200° C., and additional metal threads are located in the mesh fabric for improving the heat conductivity.

7. The press according to claim 1, wherein the transport band has a gas-permeable construction in both horizontal and vertical directions in the region contacting the work piece (1).

8. The press according to claim 7, wherein a protective film is provided between the transport band (4) and a bottom side (6) of the vacuum chamber (14).

9. The press according to claim 1, wherein there is a gas-tight separation film (5) arranged between the work piece (1) and the membrane (11), and the separation film prevents contact of the membrane (11) with gases discharged from the work piece (1).

10. The press according to claim 1, wherein there is a separation film (5) arranged between the work piece (1) and the membrane (11), and the separation film covers the membrane (11) within the vacuum chamber (14) to form a complete cover relative to the product space (16).

11. The press according to claim 1, wherein there is a separation film (5) arranged between the work piece (1) and the membrane (11), and the separation film is structured on a surface thereof facing the work piece (1) to enable gas transport along the surface.

12. The press according to claim 1, wherein the membrane (11) is structured on a surface facing the work piece (1) to enable gas transport along the surface.
